(19) United States
(12) Patent Application Publication
(10) Pub. No.: US 2013/0019794 A1
(43) Pub. Date: Jan. 24, 2013

(54) Corrosion-Resistant, Ultra-Strong, Universal Holder

(71) Applicant: Terrell Neal, Blowing Rock, NC (US)

(72) Inventor: Terrell Neal, Blowing Rock, NC (US)

(21) Appl. No.: 13/185,978

(22) Filed: Jul. 19, 2011

(51) Int. Cl. F16M 13/00; B23P 11/00; G09F 17/00

(52) U.S. Cl. 116/173; 248/314; 248/311.2; 29/428

(57) ABSTRACT

A universal holder that can hold anything that has a pole-like or rod-like insert base. It is extremely strong with respect to sideways pulls and is highly resistant to corrosion. An upper pipe section made typically made from PVC pipe has an upper end open and a lower end closed. The lower end can be fitted with a threaded nut. A stainless steel pipe or rod, which is highly corrosion resistant can have an upper end threaded to mate into the threaded nut. The pipe or rod can receive a point or a pointed spike at its bottom end for insertion into soil or sand. This point or spike can be aluminum. Alternatively, a solid stainless steel rod can tapered on the lower end into a point. The universal holder of the present invention can be used to hold fishing poles, flag poles, flower pots, lanterns and numerous other items. It can also be paired with a second similar holder to hold a clothesline or the like. Various different accessories can be used with the universal holder to hold numerous diverse items. A particular accessory is a special type of flag pole that holds a flag at an angle and allows it to turn in the wind.

### BACKGROUND

1. Field of the Invention

The present invention relates generally to the field of holders and more particularly to a universal holder that can hold any item with a insert-type base.

2. Description of the Prior Art

Numerous supports and holders are known in the art. In particular, there are numerous types of fishing pole holders. An example of a fishing pole holder is the “CPI Sand Spike” sold by various fishing outlets. This device consists of an aluminum pipe section welded onto an aluminum solid rod that can be inserted into beach sand to hold a fishing pole. The problem with this device is that it is not very strong and cannot tolerate a large sideways pull without bending the aluminum rod. Also, it does not come apart for easy storage.

In U.S. Pat. No. 2,652,999, Lohma teaches a tube-like horizontal fishing pole holder.

In U.S. Pat. No. 6,050,020, Sizemore teaches a mountable pole holder generally of use for a boat.

A similar device is shown by Nelson in U.S. Design Pat. No. D230,356. Other holder devices are shown in other U.S. Design Patents. Walls et al. in D,484,446 show a pole holder made mostly from rods. Perry in D589,113 shows a pipe-like holder.

What is badly needed, is a universal holder that can be supplied with various attachments and can hold anything with an insert base. The device should be very strong and should break apart for easy transportation and storage. The device should also be highly corrosion resistant so that it can be used outdoors indefinitely even near the sea.

### SUMMARY OF THE INVENTION

The present invention relates to a universal holder that can hold anything that has a pole-like or rod-like insert base. It is extremely strong with respect to sideways pulls and is highly resistant to corrosion. An upper pipe section made typically made from PVC pipe has an upper end open and a lower end closed. The lower end can be fitted with a threaded nut. A stainless steel pipe or rod, which is highly corrosion resistant can have an upper end threaded to mate into the threaded nut. The pipe or rod can receive a point or a pointed spike at its bottom end for insertion into soil or sand. This point or spike can be aluminum. Alternatively, a solid stainless steel rod can tapered on the lower end into a point. The universal holder of the present invention can be used to hold fishing poles, flag poles, flower pots, lanterns and numerous other items. It can also be paired with a second similar holder to hold a clothesline or the like. Various different accessories can be used with the universal holder to hold numerous diverse items. A particular accessory is a special type of flag pole that holds a flag at an angle and allows it to turn in the wind.

### DESCRIPTION OF THE FIGURES Attention is now directed to several drawings that illustrate features of the present invention:

FIG. 1 shows an embodiment of the universal holder assembled.

FIG. 2 shows the embodiment of FIG. 1 disassembled.

FIG. 3 shows the universal holder holding a fishing pole.

FIG. 4 shows an embodiment of the universal holder holding an umbrella.

FIG. 5 shows an embodiment of the universal holder holding a special flag-pole accessory.

FIG. 6 shows an embodiment of the universal holder holding a flower pot accessory.

FIG. 7 shows an embodiment of the universal holder holding a torch.

FIG. 8 shows an embodiment of the universal holder holding a lantern.

FIG. 9 shows a pair of universal holders hold a clothesline accessory.

FIG. 10 shows a pair of universal holders holding a cooking pot.

FIG. 11 shows an embodiment holding a tree-type bird feeder.

FIG. 12 shows an embodiment holding a hose nozzle.

Several drawings and illustrations have been presented to aid in understanding the present invention. The scope of the present invention is not limited to what is shown in the figures.

### DESCRIPTION OF THE INVENTION

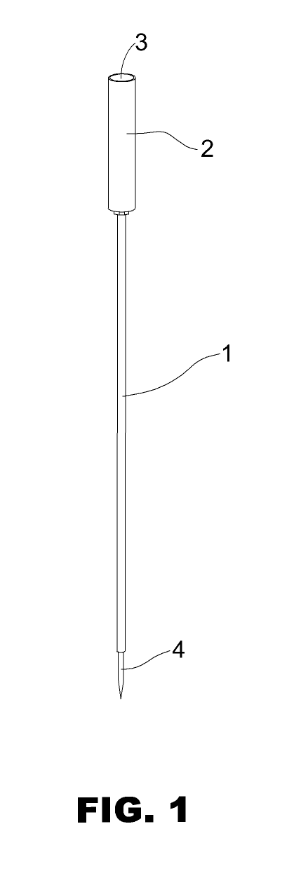

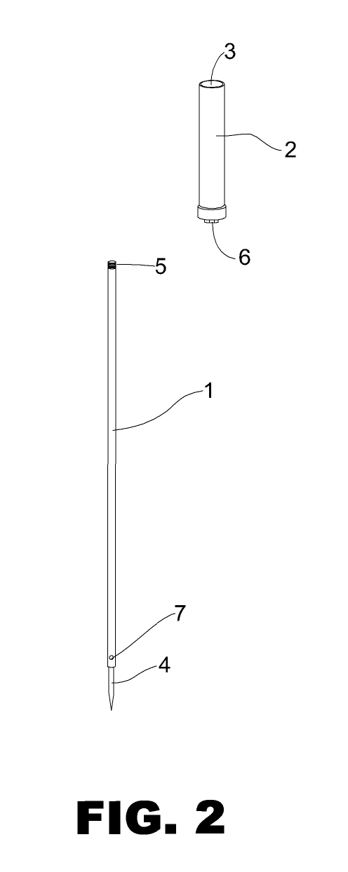

The present invention relates to a universal holder. Turning to FIGS. 1-2, a preferred embodiment of the universal holder is seen. An upper pipe or tube 2 has an open end 3 and a lower closed end. This pipe or tube is preferably made from PVC pipe. The preferred diameter is around 1½ inches ID; the preferred diameter range is between 1¼ inches to 1¾ inches. While PVC is the preferred material for the upper part, any non-corrosive material may be used including corrosion-resistant metals and plastics. Any corrosion resistant material is within the scope of the present invention. The upper pipe 2 can have a length between 6 inches and 10 inches with around 8 inches being preferred. On the closed end of the upper section 2, a threaded bushing or nut 6 can be embedded or otherwise firmly attached to the bottom of the tube 2. It is very desirable that the bushing 6 be highly corrosion resistant. The preferred material is brass or stainless steel. The preferred size of the bushing 6 is around ½×⅜ inches.

A stainless steel pipe or rod 1 of around ⅜ in. diameter can be threaded on its upper end 5 to mate with the threads in the bushing 6. The preferred material is ⅜ inch 316 stainless pipe. While other materials can be used, stainless steel is preferred since its 2% yield stress is usually over 35,000 psi making it very resistant to bending under load. The diameter of the pipe or rod 1 can be between ¼ inch and ½ inch. The stainless steel pipe or rod 1 can be of any length with about 32-38 inches being a preferred length. It should generally be in a length range from 2 feet to 4 feet; however any length is within the scope of the present invention. The bottom end of the stainless steel pipe can receive a point or a pointed spike 4. If a solid rod is used, the bottom can be bored out to receive the spike or can be tapered to a point. The point or spike 4 can be held in the pipe 1 by a rivet 7 or with another type of fastener. Any way of fastening the point to the pipe or rod is within the scope of the present invention. The point or spike can be aluminum or other corrosion-resistant metal. The preferred length of the point 4 is around 2-4 inches.

FIG. 1 shows the embodiment assembled, while FIG. 2 shows the embodiment disassembled. It is desirable that the universal holder of the present invention be easily stored and transported. The ability to remove the upper tube 2 from the stainless steel pipe or rod 1 makes transportation easier.

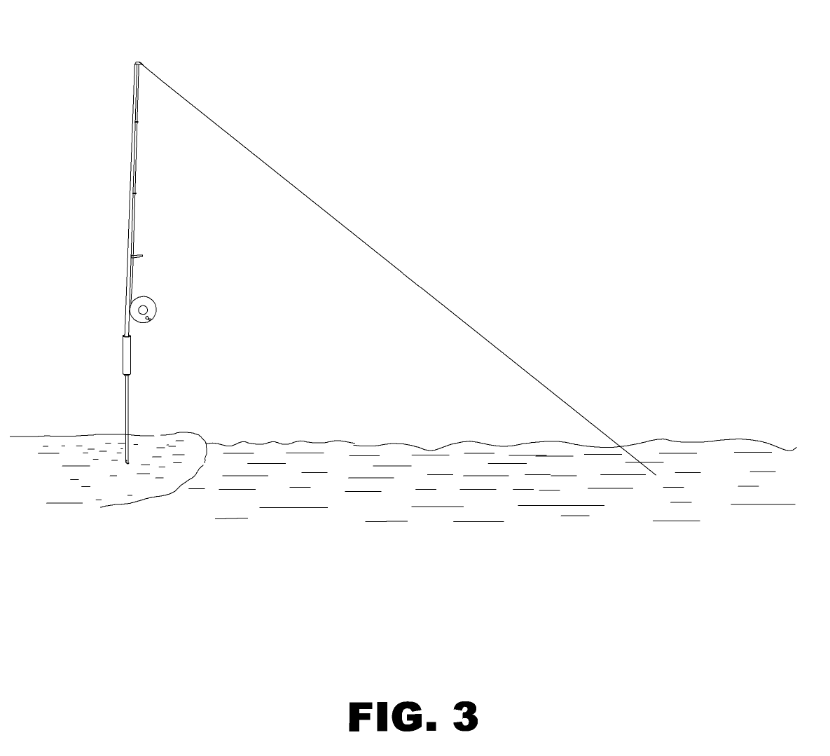

The universal holder of the present invention can be used with or without accessories to hold anything that has a pole or rod-like insert base or bottom. FIG. 3 shows an embodiment of the invention holding a fishing pole. While the universal holder can hold the fishing pole at any angle, vertical is preferred to give maximum strength against sideways pulls. The stainless steel pipe or rod 1 is extremely strong and resistant to bending as well as highly corrosion resistant.

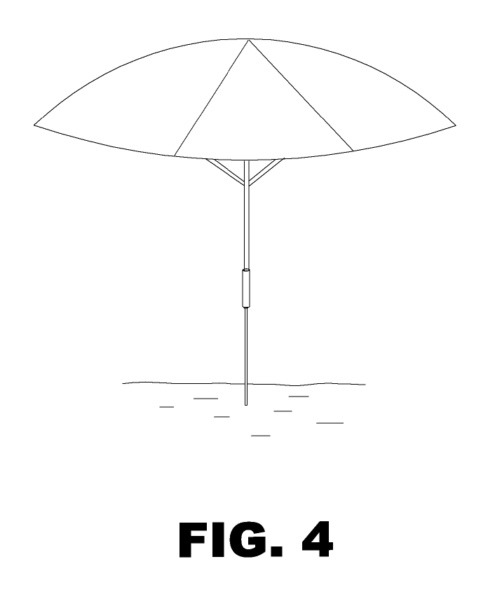

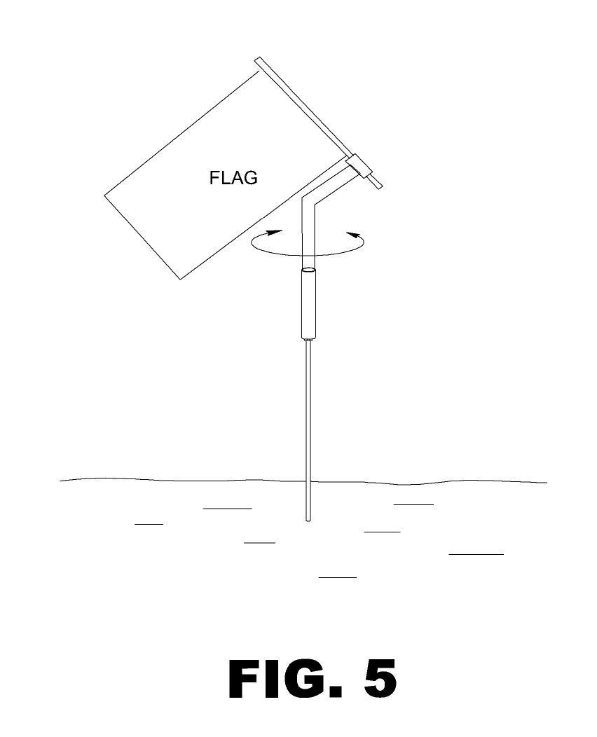

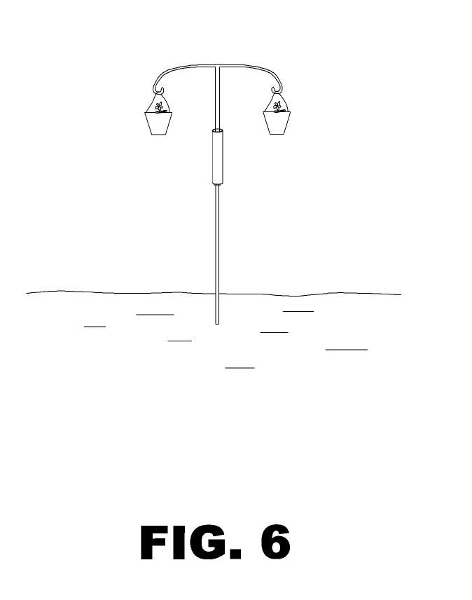

FIG. 4 shows an embodiment of the universal holder holding an umbrella, while FIG. 5 shows it holding a special flag pole accessory, and FIG. 6 shows it holding a flower pot accessory.

The special flag pole accessory shown in FIG. 5 can be conveniently made from sections of PVC pipe or other material. It can be designed as shown in FIG. 5 to hold the flag at an angle. This allows the flag to turn in the wind. A lower section of tube or rod has an angle of around 45 degrees and thus points upward at an angle when its lower end is inserted into the universal holder. A flag attachment section is attached to the upper end of the tube or rod as a second tube or rod at around 90 degrees as shown in FIG. 5. This upper tube or rod can hold a flag by tying the flag to it, having rings or otherwise allowing a flag to be attached to it. The flag flies at an angle and the entire assembly can turn freely in the wind since the lower section of tube or rod loosely fits into the upper tube of the universal holder. Alternatively, a straight vertical flagpole can also be held by the present invention.

A flower pot accessory shown in FIG. 6 can also be made from PVC tubing or other material. It can be made to hold one, two or any number of flower pots. It can be adapted to hold flower pots on an upper arm by having a curved hook, or if a straight piece of tubing, by having notches for wires from the flower pots. Alternatively if the arm is horizontal, the flower pots can simply hang from the arm with wires without notches.

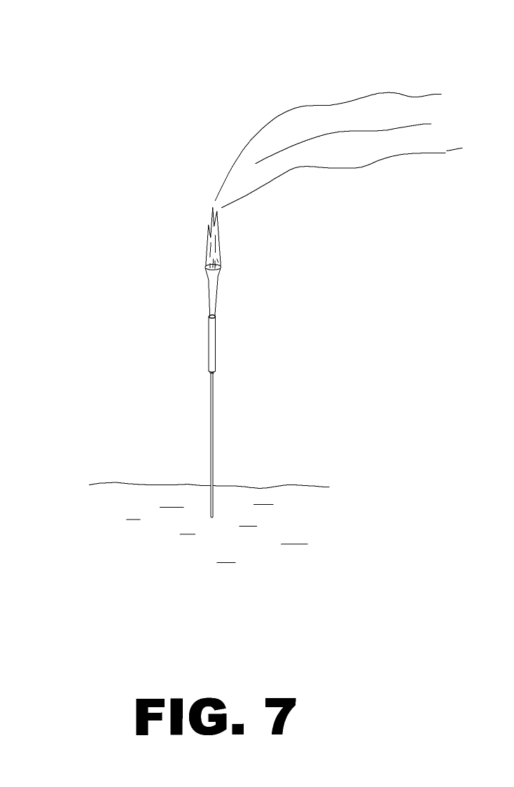

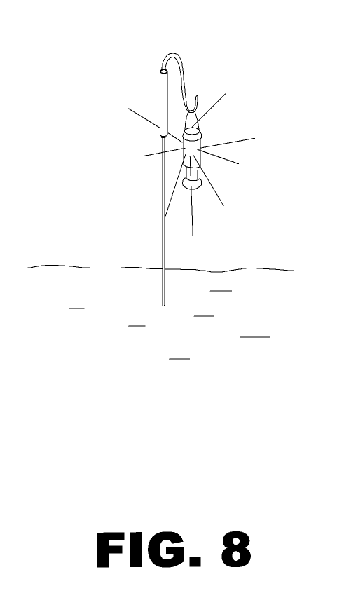

FIG. 7 shows the present invention holding a torch, while FIG. 8 shows it holding a lantern.

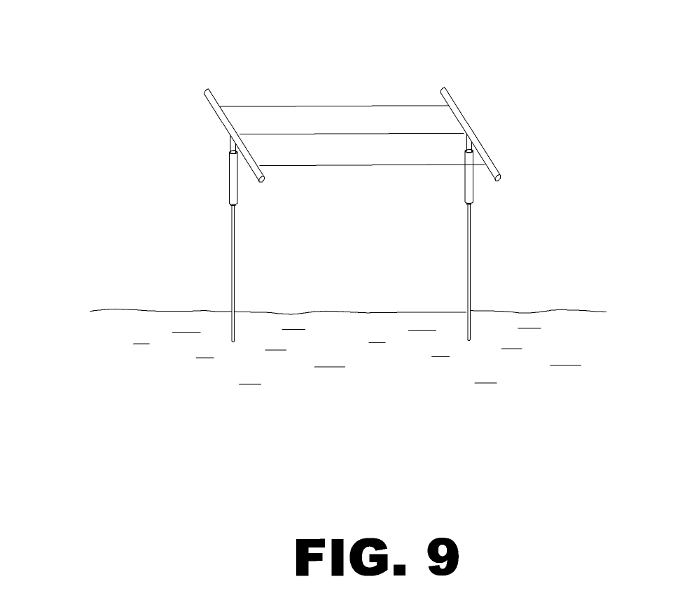

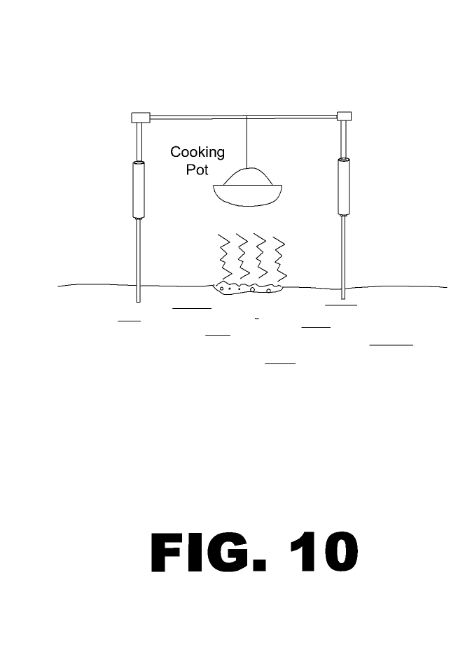

It is possible to use more than one universal holder to hold more complex items. FIG. 9 shows two universal holders holding a clothesline. This configuration is especially useful for a camping trip. FIG. 10 shows two universal holders holding a cooking pot over an open fire—also useful on camping trips.

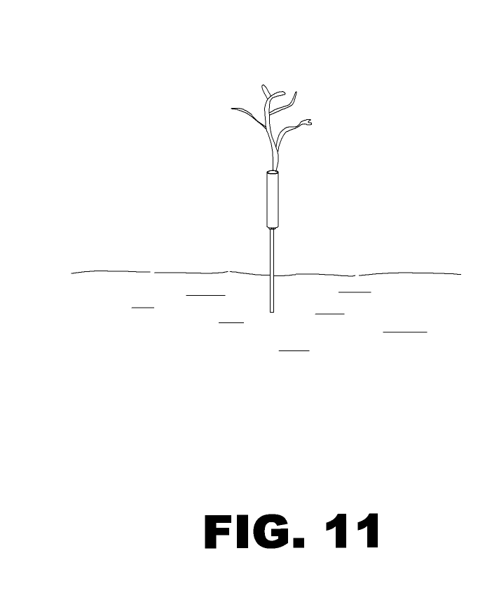

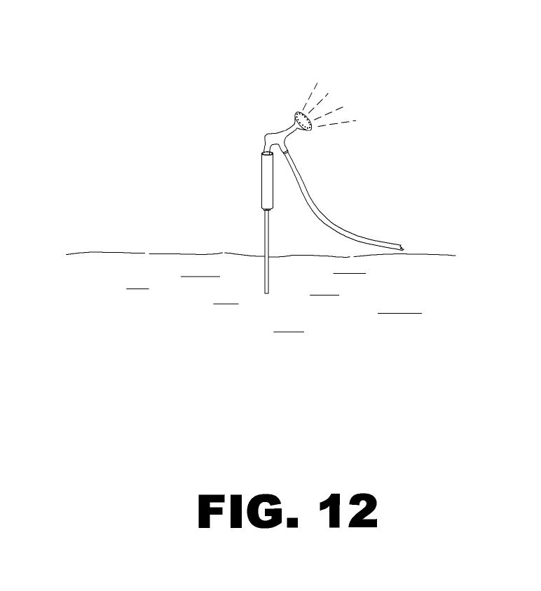

FIG. 11 shows a tree-branch bird feeder being held by the universal holder, while FIG. 12 shows the universal holder holding a hose nozzle. As previously stated, the universal holder of the present invention can hold anything that has a pole or rod-like insert lower end or bottom. Multiple universal holders can hold more complex items like clothes lines and cooking pots.

Several descriptions and illustrations have been given to aid in understanding the features of the present invention. One with skill in the art will understand that numerous changes, variations and additions of accessories can be made without departing from the spirit of the invention. Each of these changes, variations or additions is within the scope of the present invention.

I claim:

1. A universal holder comprising:
an upper tube of length between 6 inches and 10 inches with inside diameter between 1¼ inches and 1¾ inches having a open top and a closed bottom, said closed bottom having a threaded nut attached at a center-point, said nut having internal threads facing downward. a metal pipe or rod of length between 2 feet and 4 feet and diameter of around between ¼ inch to ½ inch threaded on an upper end in order to mate with the threads in said nut;
a corrosion-resistant metal point at a bottom end of said pipe or rod;
wherein, said pipe or rod has a 2% yield stress of around 35000 psi;
whereby, said universal holder can be assembled by screwing said stainless steel rod into said nut and can be pushed or driven into the ground in order to support an object that is partially inserted into said upper tube.

2. The universal holder of claim 1 wherein said metal pipe or rod is 316 stainless steel pipe.

3. The universal holder of claim 1 wherein said metal point is aluminum.

4. The universal holder of claim 1 further including a flag holder comprising:
a first section of rod or tubing having a lower end and an upper end with a an angle near 45 degrees near its center; a second section of rod or tubing attached to the upper end of the first section of rod or tubing at an angle of near 90 degrees and extending further upward, said second section of rod or tubing being adapted to fly a flag; wherein, said lower end of the first rod or tubing can be inserted into said upper tube of the universal holder in a loose fit so that the flag holder can rotate in wind.

5. The universal holder of claim 1 further comprising a flower-pot hanging accessory, said accessory having a support tube or rod that inserts into the upper tube of the universal holder and one or more arms attached to the support tube adapted to hold one or more flower pots.

6. A method of holding diverse items comprising:
providing a universal holder, said universal holder including:
an upper tube of length between 6 inches and 10 inches with inside diameter between 1¼ inches and 1¾ inches having a open top and a closed bottom, said closed bottom having a threaded nut attached at a center-point, said nut having internal threads facing downward.
a stainless steel pipe of length between 2 feet and 4 ½ feet and diameter of around between ¼ inch to ½ inch threaded on an upper end in order to mate with the threads in said nut;
a corrosion-resistant metal point at a bottom end of said pipe;
pushing said universal holder into the ground;
inserting a particular item into said upper tube such that said item is supported by said universal holder.

7. The method of claim 6 wherein said particular item is a fishing pole.

8. The method of claim 6 wherein said particular item is a flag pole.

9. The method of claim 6 wherein said particular item is a flower pot accessory.

10. The method of claim 6 wherein said particular item is a bird feeder.

11. The method of claim 6 wherein said universal holder is a first universal holder and further comprising pushing a second universal holder into the ground at a predetermined distance from said first universal holder; inserting a first leg of a clothes line into the upper tube of said first universal holder and inserting a second leg of a clothes line into the upper tube of said second universal holder.

12. The method of claim 6 wherein said universal holder is a first universal holder and further comprising pushing a second universal holder into the ground at a predetermined distance from said first universal holder; mounting a horizontal support between the upper ends of said first and second universal holders; hanging a cooking pot from said support.

13. The method of claim 6 wherein said particular item is a hose nozzle.

14. The method of claim 6 wherein said particular item is a torch or lantern accessory.
